(19) United States
(12) Patent Application Publication
(10) Pub. No.: US 2016/0080657 A1
(43) Pub. Date: Mar. 17, 2016

(54) IMAGE CAPTURING DEVICE AND DIGITAL ZOOM METHOD

(71) Applicant: Altek Semiconductor Corporation, Hsinchu City (TW)

(72) Inventors: Hong-Long CHOU, Hsinchu County (TW); Yi-Hong TSENG, Hsinchu City (TW); Yu-Chih WANG, Tainan City (TW); Che- Lun CHUANG, Hsinchu City (TW); Chia-Chun TSENG, Hsinchu City (TW); Tai-Chang YANG, Hsinchu City (TW); Wen-Yan CHANG, Miaoli County (TW); Tsan-Wei WANG, Taitung County (TW)

(21) Appl. No.: 14/526,759

(22) Filed: Oct. 29, 2014

(30) Foreign Application Priority Data
Sep. 16, 2014 (TW) 103131837

(51) Int. Cl. H04N 5/232; G06T 7/00

(52) U.S. Cl. CPC H04N 5/23296; H04N 5/23212; H04N 5/23232; H04N 5/23293; G06T 7/0097; G06T 2207/20221

(57) ABSTRACT

The present invention discloses an image capturing device and a digital zoom method. The image capturing device comprises a first lens module, a second lens module, a feature extraction unit, an image zooming-deformation unit and an image merging unit. The first lens module and the second lens module are applied to capture a first image and a second image, respectively. The feature extraction unit extracts a plurality of first image features and second image features from the first image and the second image, respectively, and generating pixel offset characteristics. Based on a zoom factor and the pixel offset characteristics, the image zooming-deformation unit zooms and deforms the first and second images to generate a third image and a fourth image. The image merging unit bases the zoom factor to merge the third image and the fourth image for obtaining a combined image.

### CROSS-REFERENCE TO RELATED APPLICATION

This application claims priority from Taiwan Patent Application No. 103131837, filed on Sep. 16, 2014, in the Taiwan Intellectual Property Office, the content of which are hereby incorporated by reference in their entirety for all purposes.

### BACKGROUND OF THE INVENTION

1. Field of the Invention

The following description relates to an image capturing device and a digital zoom method, in particular with respect to an image capturing device and a digital zoom method using multiple lenses to improve digital zoom quality.

2. Description of the Related Art

Compared with the optical focusing technique, extra optical mechanism is unnecessary to digital one that is benefit to downsize camera and reduce cost; however, the digital focusing technique has the to-be-solved technical problems itself. Because it is incapable of maintaining the image details when digital image is zoomed in, the more the magnifying power is zoomed in, the vaguer and more distorted the image will be.

As a result, some digital cameras, which are disposed with a wide-angle lens and a telephoto lens, are using to resolve the aforementioned technical problem by means of bilens. The field of view shot by the wide-angle lens is wider, but with less image details; to the contrary, the field of view shot by the telephoto lens is narrower, but with more image details. Consequently, this kind of the camera shows the image shot by the wide-angle lens to user, and then switches to the images shot by the telephoto lens when the user zooms in the zoom factor. The method, however, enables the user feeling uncomfortable when seeing the jump phenomena caused by switching the focusing.

### SUMMARY OF THE INVENTION

In view of the aforementioned technical problems, purpose of the present invention is to provide an image capturing device which may comprise a first lens module, a second lens module, a feature extraction unit, an image zooming-deformation unit and an image merging unit. The first lens module may adapt to capture a first image, the second lens module may adapt to capture a second image, the first and the second lens modules having a fixed focal length, and the focal length of the second lens module may be larger than that of the first lens module. The feature extraction unit may adapt to extract a plurality of first image features of the first image and a plurality of second image features of the second image, and may generate pixel offset characteristics among the first and the second images. The image zooming-deformation unit may adapt to zoom and deform the first and the second images according to a zoom factor and the pixel offset characteristics so as to generate a third image and a fourth image respectively; and the image merging unit may adapt to merge the third and the fourth images according to the zoom factor to generate a combined image.

Preferably, the image capturing device may further include an input unit for a user to input the zoom factor.

Preferably, a size and a view angle of the fourth image may be close to a central region in the third image.

Preferably, the image capturing device may further include a display unit for displaying the combined image.

Preferably, the image merging unit may merge the third and the fourth images according to a dynamic weighting method, and the dynamic weighting method may automatically determine weighting values of a plurality of first pixels and a plurality of second pixels based on the zoom factor and a plurality of first pixels of the third image and a plurality of second pixels of the fourth image to automatically determine weighting values of the plurality of first pixels and the plurality of second pixels.

The present invention further provides a digital zoom method which may be applicable to an image capturing device having a first lens module, a second lens module, a feature extraction unit, an image zooming-deformation unit and an image merging unit; wherein a focal length of the second lens module may be larger than that of the first lens module, and the digital zoom method may comprise: (a) respectively capturing a first image and a second image by the first lens module and the second lens module; (b) extracting a plurality of first image features of the first image and a plurality of second image features of the second image by the feature extraction unit, and generating pixel offset characteristics among the first and the second images based on the plurality of first image features and the plurality of second image features; (c) respectively zooming and deforming the first and the second images based on a zoom factor and the pixel offset characteristics by the image zooming-deformation unit, and generating a third image and a fourth image; and (d) merging the third and the fourth images based on the zoom factor by the image merging unit to generate a combined image.

Preferably, the pixel offset characteristics may be generated by comparing the plurality of first image features with the plurality of second image features.

Preferably, a size and a view angle of the third image may be close to the fourth image.

Preferably, step (d) may further comprise: determining weighting values of the third and the fourth images based on the zoom factor, and merging the third and the fourth images based on the weighting values.

According to the preceding description, a image capturing device and a digital zoom method according to the present invention may have one or more following advantages:

Firstly, an image capturing device and a digital zoom method of the present invention are able to obviously decrease vagueness and distortion caused by digital focusing.

Secondly, an image capturing device for capturing images and a digital zoom method of the present invention are able to provide smooth and clear digital focusing result aiming to the application of switching between long focus and short focus.

### BRIEF DESCRIPTION OF THE DRAWINGS

Hereinafter, embodiments of the present invention will be described in detail with reference to the accompanying drawings so that those skilled in the art to which the present invention pertains can realize the present invention, wherein:

FIG. 1 is a block diagram of an embodiment of an image capturing device according to the present invention.

FIG. 2 is a schematic diagram of an embodiment of an image capturing device according to the present invention.

FIG. 3 is a flow chart of an embodiment of a digital zoom method according to the present invention.

### DETAILED DESCRIPTION OF THE PREFERRED EMBODIMENTS

Hereinafter, embodiments of the present invention will be described in detail with reference to the accompanying drawings so that those skilled in the art to which the present invention pertains can realize the present invention. As those skilled in the art would realize, the described embodiments may be modified in various different ways, all without departing from the spirit or scope of the present invention.

The exemplary embodiments of the present invention will be understood more fully from the detailed description given below and from the accompanying drawings of various embodiments of the invention, which, however, should not be taken to limit the invention to the specific embodiments, but are for explanation and understanding only.

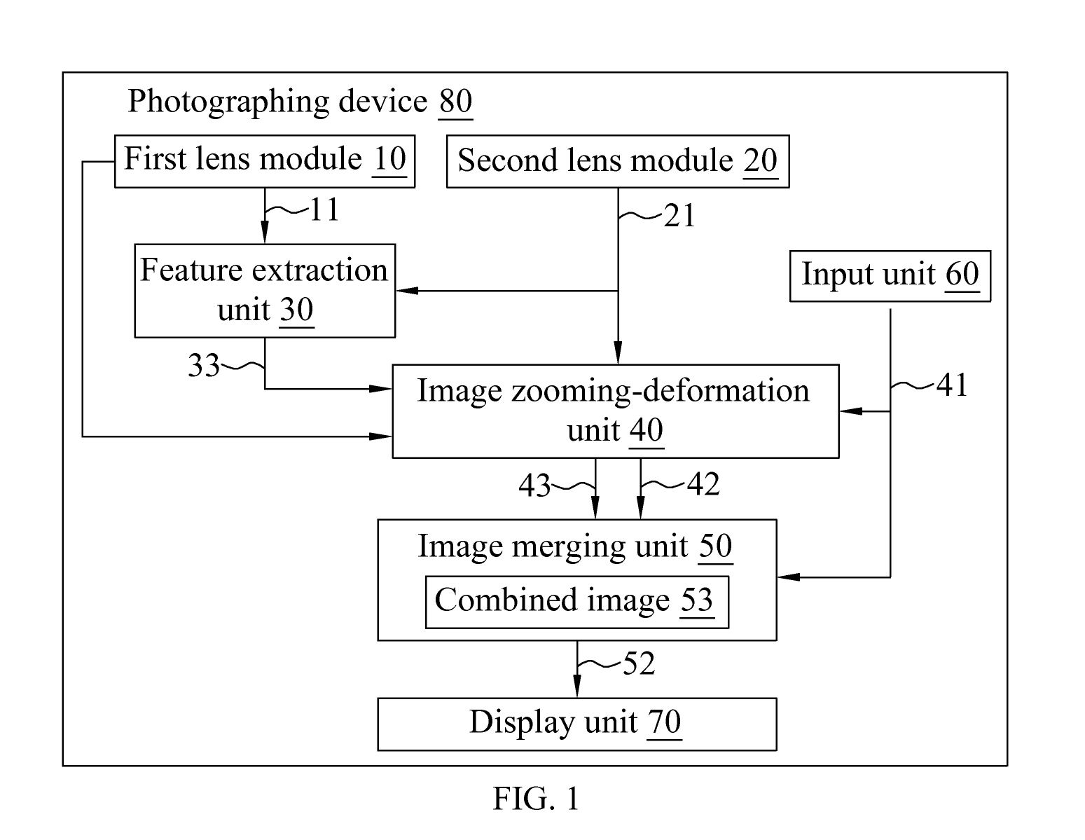

Please refer to FIG. 1 which is a block diagram of an embodiment of an image capturing device according to the present invention. As the FIG. 1 shows, the image capturing device comprises a first lens module 10, a second lens module 20, a feature extraction unit 30, an image zooming-deformation unit 40 and an image merging unit 50. The image capturing device of the present invention is operated on a photographing device 80, the first 10 and the second 20 lens modules have a fixed focus, and are both mounted at the same side of the photographing device and faced to the same direction.

The feature extraction unit 30, the image zooming-deformation unit 40 and the image merging unit 50 are executed by a way of software in a processing unit embedded in the photographing device 80. For example, the feature extraction unit 30, the image zooming-deformation unit 40 and the image merging unit 50 are respectively program codes which can be executed by the processing unit, and respectively to form an application after being compiled, or are executed by a way of hardware; namely, the feature extraction unit 30, the image zoom-deformation unit 40 and the image merging unit 50 are respectively the specific circuits of the processing unit. In addition, the photographing device 80 further comprises an input unit 60 and a display unit 70.

The first lens module 10 and the second lens module 20 respectively comprise an image-capturing lens and an image sensor, and the image-capturing angle of the image-capturing lens of the first lens module 10 is larger than that of the second lens module 20. The first lens module 10 is applied to capture a first image 11, and the second lens module 20 is applied to capture a second image 21. In the embodiment, the image-capturing lens of the first lens module 10 can be a wide-angle lens, and the image-capturing lens of the second lens module 20 can be a telephoto lens, and field of view of the second lens module 20 is smaller than that of the first lens module 10.

The aforementioned image sensor may be an image sensor using charge-coupled device (CCD) or complementary metal-oxide-semiconductor (CMOS).

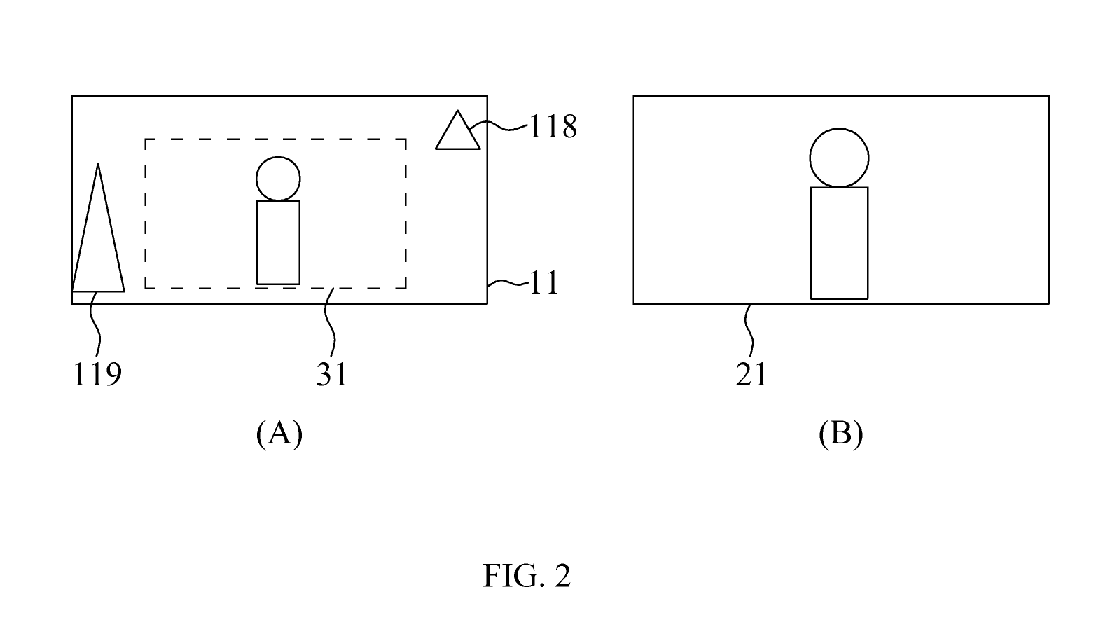

The feature extraction unit 30 is applied to respectively extract a plurality of first image features of the first image 11 and a plurality of second image features of the second image 21, and generate pixel offset characteristic 33 based on the plurality of first image features and the plurality of second image features. The pixel offset characteristic 33 are used to determine an image block in the second image 21 corresponding to the first image 11. As FIG. 2 shows, part (A) shown in the FIG. 2 demonstrates the first image 11, and part (B) indicates the second image 21. As the image-capturing lens of the first lens module 10 is a wide angle lens, size of the same objective in the first image 11 is smaller than that of the second image 21; however, the first lens module 10 is able to capture a wider range, surroundings of the first image 11 has objectives 118 and 119 which are not shown in the second image 21.

Because the first lens module 10 and the second lens module 20 are mounted at the same side of the photographing device 80 and faced toward the same direction, it can determine a region 31 in the second image 21 corresponding to the first image 11 by capturing the second image feature 22 of the second lens module 20.

In addition, the image zooming-deformation unit 40 respectively zooms and deforms the first 11 and the second 21 images based on the zoom factor 41 provided by the input unit 60 to generate a third image 42 and a fourth image 43. For example, when the input zoom factor 41 inputted by a user via the input unit 60 is a multiple of 1.1, the image zooming-deformation unit 40 zooms in the first image 11 by about a multiple of 1.1 to form the third image 42, and zooms out the second image 21 by about a multiple of 0.5 to form the fourth image 43; wherein a size and a view angle of the third image 42 are close to the fourth image 43. Besides, the image zooming-deformation unit 40 further respectively deforms and adjusts the first image 11 and the second image 21 by the corresponding image features in the first image 11 and the second image 21 extracted by the feature extraction unit 30 to generate the third 42 and the fourth 43 images to enable the corresponding regions in the first 11 and the second 21 images comparing with each other. For example, using the coordinates of the pixels of the corresponding regions to compare with each other.

Subsequently, the image merging unit 50 determines the weighting in the third image 42 and the fourth image 43 in the process of blending images based on the zoom factor 41 provided by the input unit 60; namely, a blending weighting of the third image 42 and the fourth image 43, and conducts the image fusion to the third 42 and the fourth 43 images to generate a combined image 53. For example, when the scaling 41 is a multiple of 1.1, the weighting of the first image 11 is 0.9, and that of the second image 21 is 0.1; and when the zoom factor 41 is a multiple of 1.8, the weighting of the first image 11 is 0.2, and that of the second image 21 is 0.8.

Finally, capturing a part of the combined image 53 based on a fixed display size to generate an output image 52, and a display unit 70 displays the output image 52 to enable the user seeing the shot images through the display unit 70.

According to the preceding description, the image capture using a lens having two different field of views is able to selectively generate the blending images of wide view and narrow view based on the zoom factor 41, or to generate image of narrow view so as to decrease the vagueness and distortion caused by digital focusing and consider about the smoothness while switching the long focus and short focus.

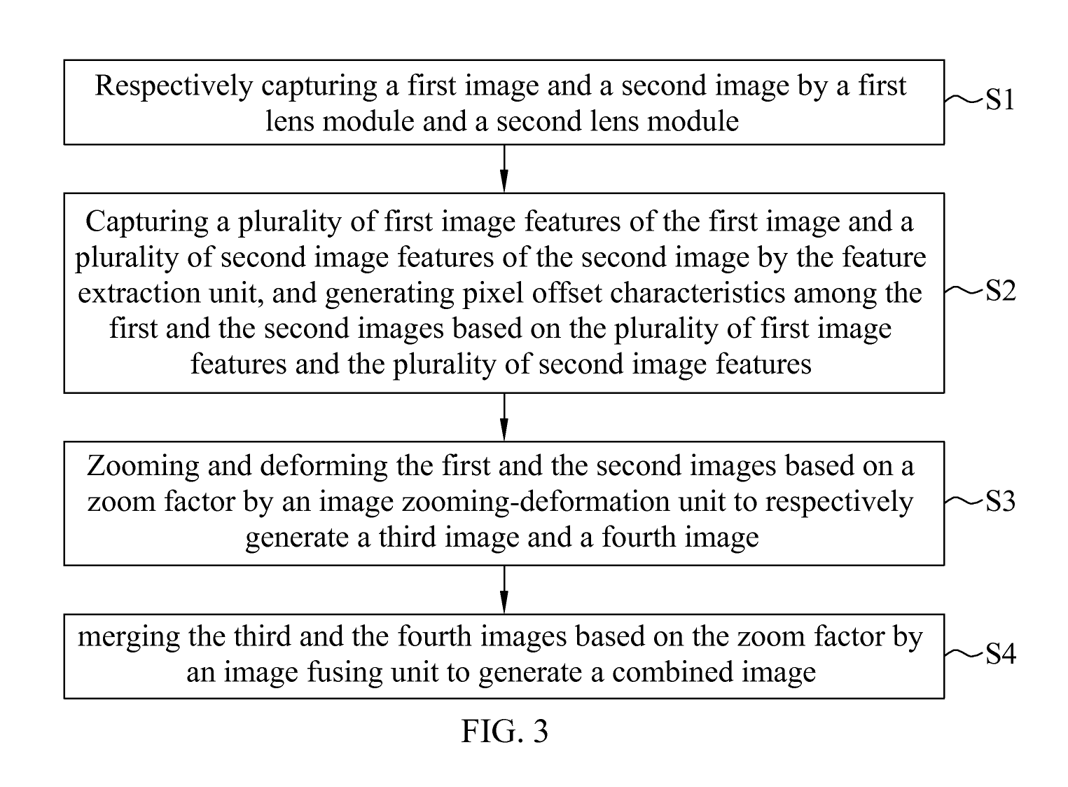

Please refer to FIG. 3 which is a flow chart of an embodiment of a digital zoom method according to the present invention. The digital zoom method is explained by collocating with FIG. 1. In the FIG. 1, the digital zoom method is applicable to a photographing device 80 having a first lens module 10, a second lens module 20, a feature extraction unit 30, an image zooming-deformation unit 40 and an image merging unit 50; wherein, a view of the second lens module 20 is smaller than that of the first lens module 10, and the digital zoom method comprises the following steps:

Step S11: Respectively capturing the first image 11 and the second image 21 by the first lens module 10 and the second lens module 20.

Step S12: Extracting the plurality of first image features of the first image 11 and the plurality of second image features of the second image 21 by the feature extraction unit 30, and generating pixel offset characteristics 33 among the first image 11 and the second image 21 based on the plurality of first image features and the plurality of second image features.

Step S13: Zooming and deforming the first image 11 and the second image 21 based on the zoom factor 41 by the image zooming-deformation unit 40 to respectively generate the third image 42 and the fourth image 43. Wherein, the step S13 further comprises receiving the zoom factor 41 by the input unit 60, and respectively zooming and deforming the first image 11 and the second image 21 based on the zoom factor 41 and the pixel offset characteristics 33 to respectively generate the third 42 and the fourth 43 images.

Step S14: Merging the third image 42 and the fourth image 43 based on the zoom factor 41 by the image merging unit 50 to generate the combined image 53. Wherein, the definition of the output image 52 is greater than that by using digital focusing to the output image 52 with the same zoom factor in the second image 21, so that vagueness and distortion caused by digital focusing can be decreased.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

1. An image capturing device, comprising:
a first lens module, adapted to capture a first image;
a second lens module, adapted to capture a second image, the first and the second lens modules having a fixed focal length, and the focal length of the second lens module being larger than that of the first lens module;
a feature extraction unit, adapted to extract a plurality of first image features of the first image and a plurality of second image features of the second image, and generating pixel offset characteristics among the first and the second images;
an image zooming-deformation unit, adapted to zoom and deform the first and the second images according to a zoom factor and the pixel offset characteristics so as to generate a third image and a fourth image respectively; and
an image merging unit, adapted to merge the third and the fourth images according to the zoom factor to generate a combined image.

2. The image capturing device of claim 1, further comprising an input unit for a user to input the zoom factor.

3. The image capturing device of claim 1, wherein a size and a view angle of the fourth image are substantially equal to a size and view angle of a central region in the third image.

4. The image capturing device of claim 1, further comprising a display unit for displaying the combined image.

5. A digital zoom method which is applicable to an image capturing device having a first lens module, a second lens module, a feature extraction unit, an image zooming-deformation unit and an image merging unit; wherein a focal length of the second lens module is larger than that of the first lens module, and the digital zoom method comprises:
(a) respectively capturing a first image and a second image by the first lens module and the second lens module;
(b) extracting a plurality of first image features of the first image and a plurality of second image features of the second image by the feature extraction unit, and generating pixel offset characteristics among the first and the second images based on the plurality of first image features and the plurality of second image features;
(c) respectively zooming and deforming the first and the second images based on a zoom factor and the pixel offset characteristics by the image zooming-deformation unit, and generating a third image and a fourth image; and
(d) merging the third and the fourth images based on the zoom factor by the image merging unit to generate a combined image.

6. The digital zoom method of claim 5, wherein the pixel offset characteristics are generated by comparing the plurality of first image features with the plurality of second image features.

7. The digital zoom method of claim 5, wherein a size and a view angle of the third image are substantially equal to a size and view angle of the fourth image.

8. The digital zoom method of claim 5, wherein step (d) further comprises: determining weighting values of the third and the fourth images based on the zoom factor, and merging the third and the fourth images based on the weighting values.
